(19) United States
(12) Patent Application Publication
(10) Pub. No.: US 2020/0250887 A1
(43) Pub. Date: Aug. 6, 2020

(54) Portable Walk-Through Organ Exhibit with Augmented and Virtual Reality

(71) Applicant: Lauren Hill, Houston, TX (US)

(72) Inventor: Lauren Hill, Houston, TX (US)

(21) Appl. No.: 16/780,702

(22) Filed: Feb. 3, 2020

Related U.S. Application Data
(60) Provisional application No. 62/800,526, filed on Feb. 3, 2019.
(60) Provisional application No. 62/929,835, filed on Nov. 2, 2019.

(51) Int. Cl. G06T 19/00; G06F 3/01; G02B 27/01; G09B 23/30; H04W 4/80

(52) U.S. Cl. CPC G06T 19/003; G06T 19/006; G06F 3/011; G02B 2027/0178; G02B 27/0172; G09B 23/30; H04W 4/80; G06F 3/016

(57) ABSTRACT

A system for exhibiting a human organ for educational purposes, the system including augmented and/or virtual reality renditions, optionally in conjunction with a physical model of the human organ. The augmented or virtual reality rendition presents at least a portion of the human organ and/or a feature of the human organ, providing for an immersive learning experience to visitors.

### CROSS-REFERENCE TO RELATED APPLICATIONS

The present application claims the benefit of U.S. Provisional Patent Application No. 62/800,526 (pending), filed on Feb. 3, 2019, the entirety of which is incorporated herein by reference; and, the present application claims the benefit of U.S. Provisional Patent Application No. 62/929,835 (pending), filed on Nov. 2, 2019, the entirety of which is incorporated herein by reference.

### FIELD

The present disclosure relates to exhibits or models of a human part or organ, and more specifically, to exhibits incorporating augmented and/or virtual reality features. The present disclosure also relates to methods of deploying, manufacturing, displaying, and/or using such an exhibit or model for academic or educational purposes.

### BACKGROUND

The human heart is arguably the most important organ in the body. Life is not possible without a functioning heart. Heart disease is the leading cause of death in the United States, accounting for one death every minute. Many forms of heart disease are preventable by altering life styles, food choices, and/or exercise patterns. Also, there are a number of methods to treat heart disease including valve replacement, cardiac bypass grafts, and coronary artery stents. There is a real need to educate the public about the types and causes of heart disease and the methods for prevention and medical treatments. This is especially true for younger people, as it is now known that some types of heart disease start with choices made in childhood.

One method to help teach people about heart disease is to use a physical or computer model of the heart. There are numerous life-size physical models, computer-generated animations, cadaver hearts, and other approaches used to help convey information about heart disease. But these often fail to effectively convey key understanding the features of the heart because it is difficult so see and comprehend the small and complex heart anatomy. And many of these approaches are not particularly engaging.

One of the most effective methods to teach people about heart disease is to use an engaging, interactive larger-than-life physical model that can be walked through so that the visitor can see the features of the heart up close. A few fixed larger-than-life walk-through heart exhibits exist. For example, the Giant Heart at the Franklin Institute in Philadelphia is a large, fixed walk-through heart exhibit that has existed and provided valuable heart education for more than 50 years. The exhibit directs visitors to walk through the heart chambers in the same pattern as normal blood flow and involves climbing stairs. The Franklin Giant Heart exhibit is large, heavy, and difficult to move. In essence, visitors must come to it, rather than it going to where the people are. This limits the number of people who could benefit from the Franklin walkthrough model of the heart and other similar fixed exhibits.

Similar to the heart, there is a real need to educate the public about other critical human organs, including the brain, the lungs, and the liver. There currently exists a number of portable, walk-through exhibits of human organs, such as the MEGA Heart®, MEGA Brain®, MEGA® Lungs, and MEGA® Body. These exhibits all use static examples or two-dimensional signs to help explain organ features and diseases, such as heart valves or plaque. While these exhibits are useful tools, it would be desirable, and perhaps more effective, if elements could be incorporated into the exhibits that can be used to facilitate the explanation of key features of the organs, such as elements in which users can immerse themselves in the environment of the organs.

### SUMMARY

Some embodiments of the present disclosure include a system for exhibiting a human organ. The system includes a physical model of at least a portion of the human organ. The physical model includes an infrastructure presenting a three-dimensional representation of at least a portion of the human organ, at a scale of at least 10:1. A walk-through passageway is defined, at least in part, by the infrastructure. The walk-through passageway is directed by or through representations of portions of the human organ. The system includes a user interface, including a display. The system includes an augmented or virtual reality initiator positioned relative to the physical model, such as in, on, or near the physical model. The system includes a software application stored in the user interface, in a host computer, or combinations thereof. The augmented or virtual reality initiator is configured to initiate the display of an augmented or virtual rendition of at least a portion of the human organ, a feature of the human organ, or combinations thereof. For example, the software application may include computer instructions to generate and/or present the augmented or virtual rendition based on the physical proximity of the user interface relative to the augmented or virtual reality initiator or based on the scanning of a bar code or QR code by the user interface.

Other embodiments of the present disclosure include a method of providing information about a human organ. The method includes displaying a physical model of the human organ. The physical model includes an infrastructure presenting a three-dimensional representation of at least a portion of the human organ, at a scale of at least 10:1. A walk-through passageway is defined, at least in part, by the infrastructure. The walk-through passageway is directed by or through representations of portions of the human organ. The method includes directing a visitor through the walk-through passageway. The method includes presenting an augmented or virtual reality rendition of at least a portion of the human organ, a feature of the human organ, or combinations thereof to the visitor. The augmented or virtual reality rendition is presented on a display of a user interface.

Other embodiments of the present disclosure include a virtual exhibit of a human organ. The virtual exhibit includes a virtual reality rendition of a model of at least a portion of the human organ. The virtual reality rendition presents a three-dimensional, virtual reality representation of at least a portion of the human organ, at a scale of at least 10:1. The virtual reality rendition defines a virtual walk-through passageway that is directed by or through the virtual reality representation of the human organ. The virtual reality rendition is presented on a display of a user interface.

Other embodiments of the present disclosure include a graphical user interface for presenting an augmented or virtual reality rendition in accordance with the present disclosure.

Other embodiments of the present disclosure include a software application for generation a graphical user interface for presenting an augmented or virtual reality rendition in accordance with the present disclosure.

### BRIEF DESCRIPTION OF THE DRAWINGS

The following figures are part of the present specification, included to demonstrate certain aspects of embodiments of the present disclosure and referenced in the detailed description herein.

FIG. 1 is a simplified partial, illustration of a human heart with a cross-sectional view illustrating blood circulation in, through, and out of the heart.

FIG. 2 is a simplified illustration of the human heart model with a walk-through passageway, according to the present disclosure.

FIG. 3A is a perspective view of an inflatable heart exhibit, according to the present disclosure.

FIG. 3B is an alternate perspective view of the exhibit in FIG. 3A.

FIG. 3C is a bottom view of the exhibit in FIG. 3A.

FIG. 3D is a detail view of an exit from the exhibit in FIG. 3A.

FIG. 3E is a detail view of an inside section of the walk-through passageway of the exhibit in FIG. 3B.

FIG. 3F is an alternate perspective view of the exhibit in FIG. 3A.

FIG. 4 is a simplified diagram representing the walk-through passageway of the exhibit in FIG. 2, with a map of locations of informational plaques along the walk-though passageway, according to the present disclosure.

FIG. 4A is a detail view inside the representation of the left ventricle.

FIG. 4B is a detail view inside the representation of the right atrium.

FIG. 5 is a schematic illustrating an exploded view of an LED strip removably attached to a ceiling surface of the walk-through passageway, according to the present disclosure.

FIG. 6 is a simplified cross-sectional view illustrating an alternative walk-through passageway through a heart, according to the present disclosure.

FIG. 7 is one exemplary application of the augmented and/or virtual reality technology disclosed herein, including the identification of organs and/or portions of organs in a human body.

FIG. 8 is another exemplary application of the augmented and/or virtual reality technology disclosed herein, including the identification of images of organs and/or portions of organs.

FIG. 9 is another exemplary application of the augmented and/or virtual reality technology disclosed herein, including the identification of images of organs, portions of organs, and/or ailments resident in organs.

FIG. 10 depicts another exemplary application of various features of a software application of the augmented and/or virtual reality technology disclosed herein.

FIG. 11 is another exemplary application of the augmented and/or virtual reality technology disclosed herein, including the identification of cancer in organs.

FIGS. 12A-12C are exemplary applications of the augmented and/or virtual reality technology disclosed herein, including the identification of tumors in organs.

FIGS. 13A-13C are exemplary applications of the augmented and/or virtual reality technology disclosed herein, including the ability to view CT scans of organs.

FIGS. 14A-14E are exemplary applications of the augmented and/or virtual reality technology disclosed herein, including the inspection of organs, the identification of cancer, and the ability to view PET scans and treatment options.

FIGS. 15A and 15B are exemplary applications of the augmented and/or virtual reality technology disclosed herein, including the ability to view information about the progression of ailments, such as cancer.

FIG. 16 is a simplified diagram of an embodiment of the system disclosed herein.

FIG. 17 is a depicts a model exhibit of a human heart with informational plaques positioned throughout the model that include QR codes, bar codes, Bluetooth transmitters/receivers, or other AR/VR feature initiators.

### DETAILED DESCRIPTION

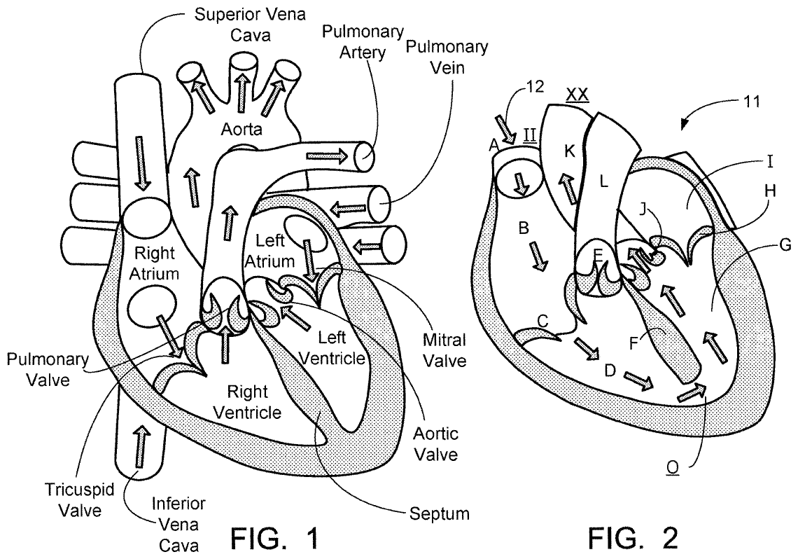

The present invention relates generally to the use of augmented reality (AR) and/or virtual reality (VR) to provide information about organs and associated ailments and treatments thereof, particularly in conjunction with a physical representation or model of the organ (e.g., a human organ). The following descriptions of FIGS. 1-6 describe exemplary human heart exhibits for which the AR and/or VR technology disclosed herein may be used in conjunction with. FIGS. 1-6 are reproduced from U.S. Pat. No. 8,727,786 ('786 patent), the entirety of which is incorporated herein by reference. However, one skilled in the art would understand that the AR and/or VR technology disclosed herein is not limited to use with the described human heart exhibit, or to any human heart exhibit, and may be used in conjunction with exhibits of other human organs, such as the human brain exhibit disclosed in U.S. patent application Ser. No. 15/460,058 ('058 application), the entirety of which is incorporated herein by reference; an exhibit of a human liver; an exhibit of human skin; an exhibit of a human kidney; an exhibit of human lungs; or any other human organ. Furthermore, the AR and/or VR technology disclosed herein is not limited to use with human organs, and may be applied to the organs of other animals, such as dogs or cats.

### Inflatable Human Heart Exhibit

Embodiments of the present disclosure are particularly adapted to a large-scale, three-dimensional representation or model of the human heart that is walk-through accessible, internally observable (can be viewed from internal perspective), and/or portable. FIGS. 2 through 5 depict an exhibit 10 including such a three-dimensional, large-scale model 11 and embodying various other aspects of the invention. The large-scale model 11 features an internal, walk-through passageway 12 that is adapted for viewing or observing the heart from an internal perspective. The walk-through passageway 12 of the invention may utilize heart disease simulations and/or selective simplifications of the heart anatomy to achieve the desired pathway through the heart. The large-scale form of the model allows for the inclusion of the walk-through passageway. The large-scale form also provides perspectives from which to view the heart and an additional platform from which to present information to the visitor. In yet another aspect of the present invention, some of the disadvantages of the large-scale form are mitigated by implementing a lightweight, portable structural design for the model. In the preferred embodiments, portability of the large-scale model is primarily achieved through utilization of an inflatable construction, as further described below.

FIG. 1 is a typical illustration of the inside of the human heart. The simplified illustration uses a cross-sectional view to show, among other things, the four chambers and four valves inside the heart. The cross-sectional view and perspective also illustrate the blood flow (circulation) in and around the human heart. The aorta and pulmonary artery are large arteries that lead out of the heart. The superior vena cave, inferior vena cava, and pulmonary veins are the large veins that empty into the heart. Deoxygenated blood is returned from the body by both vena cava and received in the right atrium of the heart. The tricuspid valve is positioned between the right atrium and right ventricle and allows one-way flow of the de-oxygenated blood into the right ventricle. As depicted in FIG. 1, the right ventricle is below the right atrium and is separated from the left ventricle by an internal wall called the septum.

From the right ventricle, blood is pumped into the pulmonary artery which splits into two, and directs blood into the right and left lung, respectively. From the lungs, oxygenated blood is returned to the heart via pulmonary veins. The oxygenated blood is received by the heart into the left atrium. From the left atrium, the blood flows directly into the left ventricle by way of the mitral valve. The oxygenated blood is pumped out of the heart from the left ventricle and through the aortic valve. The aortic valve leads into the aorta which extends from the left ventricle toward the top of the heart (in this view) and then distributes the oxygenated blood into the different parts of the body.

In the two-dimensional representation of the heart in FIG. 1, the heart takes a position and an orientation that substantially correspond with its normal position and orientation in the human body, when the person's torso is upright. The view of FIG. 1 is a front, elevation view of the heart from a generally parallel perspective at the front of the body, whereby the right chambers (atrium and ventricle) are depicted on the left side of the page and the left chambers are depicted on the left side of the page. Using this perspective, the cross-section is provided by a vertical plane that exposes each of the chambers of the heart. This vertical plane, which is in parallel to the perspective of the drawing, is in substantial alignment with the vertical orientation of the human body and the natural vertical plane occupied by sections of the heart. As used herein, this vertical plane may be referred to as the perspective plane.

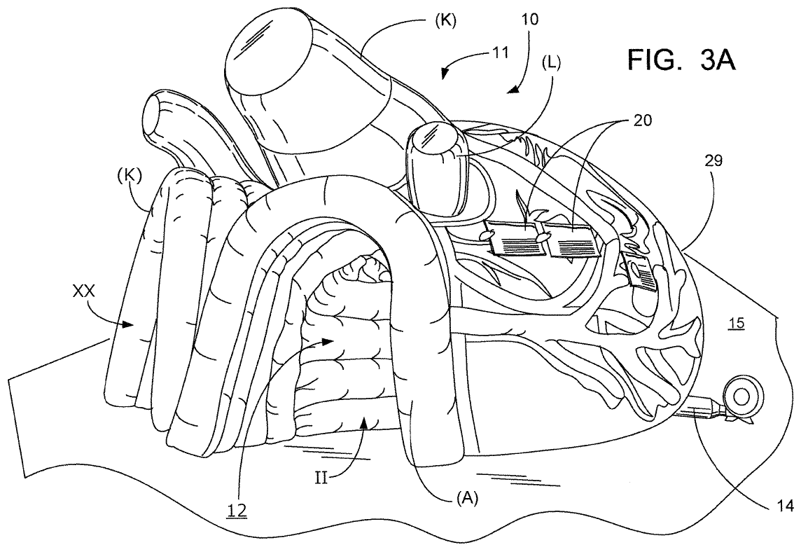

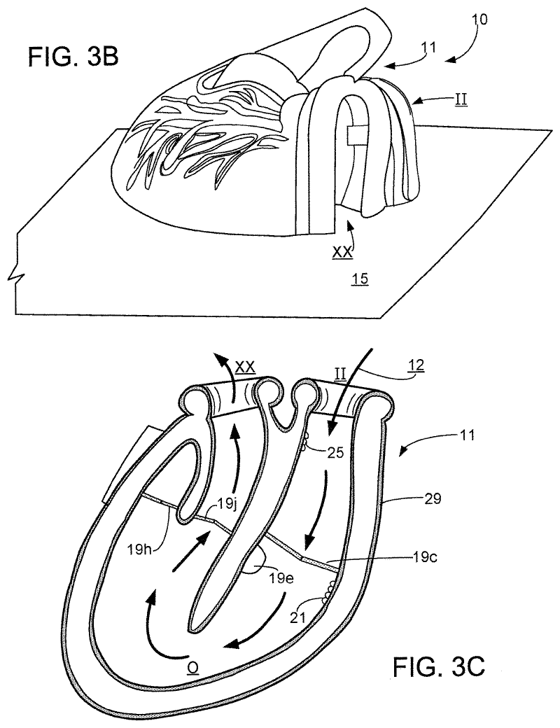

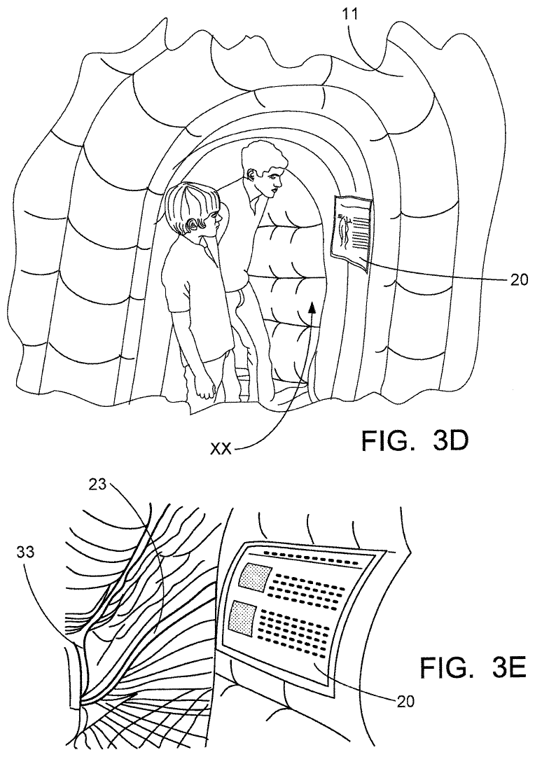

The present disclosure describes an inflatable heart exhibit, and more particularly, an inflatable heart model defined, at least partially, by a cross-sectional perspective plane that achieves, in part, a particularly advantageous walk-through passageway 12. The walk-through passageway 12 is illustrated in the simplified schematic of FIG. 2 (by directional arrows) of a heart model 11, and embodied by the exhibit 10 depicted in FIGS. 3A-3F. Referring first to FIG. 2, the intended walk-through passageway 12 features an entrance (II) provided by a representation of the superior vena cava (A) and positioned on the left (as depicted on the page of the Figure) and top of the heart. A visitor traversing the passageway enters from the superior vena cava (A) into the domed first chamber that is the right atrium (B). The visitor's entry is similar to, and corresponds with, the normal return of blood from the body into the heart. As with the de-oxygenated blood, the visitor must advance through the tricuspid valve (C) in order to pass from the right atrium (B) into the adjacent enlarged and separate chamber—the right ventricle (D). In several embodiments, the tricuspid valve (C) is represented by inflated leaflets or curtains that partially block the path between the two right chambers.

As discussed previously, the right ventricle (D) is normally bounded by an internal heart wall, the septum (F), that separates the right ventricle (D) from the left ventricle (G). To achieve the preferred walk-through passageway of the present disclosure, the vertex end of the septum (F) has been modified with an opening (0) between the right ventricle (D) and the left ventricle (G). This opening (0) allows visitors to pass from the right ventricle (D) directly into the left ventricle (G). In this embodiment, the pulmonary valve (E) that normally directs blood from the right ventricle (D) into the lungs, is represented but closed off in favor of the opening into the left ventricle (G). From the left ventricle (G), the visitor advances through the aortic valve (J) and into the exit tube which represents the aorta (K). In one or more preferred embodiments, the left atrium (I) may be closed by the mitral valve (H) to divert the visitor to the aorta (K).

In this embodiment, the opening (0) in the septum (F) also functions as a physical (i.e., three-dimensional) representation and simulation of a feature of a known heart disease—a ventricular septal defect. The ventricular septal defect allows blood to escape from the right ventricle (D) into the left ventricle (G) rather than being pumped directly into the pulmonary artery (L). This causes the heart to work harder to pump more blood, which can lead to enlargement of the heart and other health problems.

As shown in the two-dimensional illustration of FIG. 2, the walk-through passageway 12 represented by the directional arrows provides a direct and generally rectilinear route through the heart. The walk-through passageway 12 is also generally situated on one plane, a “walking plane”, and that plane is generally parallel to the perspective plane of the figure. As discussed above, this perspective (and cross-sectional) provides a useful and informative view of the inside of the heart, which also helps to illustrate the modes of blood circulation in the heart.

In one aspect of the disclosure, an inflatable heart exhibit 10 is provided that embodies the walk-through passageway 12 and perspective illustrated in FIG. 2, but in large-scale, three-dimensional form. Referring to FIGS. 3A-3F, the inflatable heart exhibit 10 is preferably constructed at a scale greater than 15:1, more preferably at a scale greater than 20:1, and most preferably, at a scale of around 25:1 or greater (e.g., 30:1). In this embodiment, the exhibit 10 includes an inflatable structure 11 (the heart model 11), a forced air inflation system including a blower 14, and an integrated mat or base 15 on which the inflatable heart structure 11 is set. The inflatable structure 11 inflates into a large-scale, three-dimensional representation or model of a human heart set upon the horizontal mat 15. The mat 15 may be attached to the inflatable structure 11, but is not required to be of an inflatable construction. In this embodiment, the inflated heart structure or simply, the heart model 11, presents a large-scale cross-section or partition of the actual heart. The sectional plane is provided near the “back” of the heart and corresponds with the plane of the mat 15. This cross-sectional plane also substantially corresponds with the cross-sectional planes used in FIG. 2 to show the walk-through passageway except the perspective view is reversed (nearly a rear perspective rather than a nearly front perspective). As will be further shown below, the cross-sectional plane of the heart structure 10, as provided by the mat 15, also corresponds to the perspective plane discussed in respect to FIG. 1. In one respect, the inflated heart model 11 is a three-dimensional embodiment of FIG. 2 with the heart oriented and positioned as if laid flat and engaging the surface (i.e., the mat 15).

The mat 15 and the cross-section also define, at least partly, a three-dimensional walk-through passageway 12 as targeted in FIG. 2. In one aspect, the resulting walk-through passageway (of the three-dimensional exhibit) is generally horizontal and thus, the pathway is maintained at one level or story (the bottom plane of which is defined by the mat 15). The mat 15 also defines the perspective plane from which the inside of the heart may be viewed. Thus, when the visitor is on the walk-through passageway and looking up, the visitor takes a perspective substantially corresponding to the aforementioned perspective plane (except that the view is a rear view). The three-dimensional form of the walk-through passageway also allows the same visitor to stand in any portion of the walk-through passageway and look around to observe the internal walls of the heart and any information presented thereon.

The infrastructure of the model 11 is designed to remain inflated as long as there is a continuous flow of air passing through the structure. The heart structure 11 contains a variety of vented chambers and passages, which inflates when the forced air system 14 is activated. Upon inflation, these chambers and passages provide the infrastructure of the model 11 and to some extent, the exhibit 10. It should be noted that the construction and procedure for unfolding and inflating a structure, such as the heart structure 11, is generally known in the relevant art. Portability of the exhibit 10 may be achieved, in part, by fabricating the walls and layers of heart structure 11 out of very lightweight materials. In a preferred embodiment, the heart model 11 employs a lightweight, low-permeability polymer (e.g., PVC) fabric and the entire heart model 11 weighs less than 1000 lbs. Further, the exhibit 10, including the model 11 and mat 15 can be deflated, disassembled, and stowed into a volume that is less than 50 cubic feet.

Referring to FIGS. 2 and 3A, an exaggerated representation of the superior vena cava (A) is positioned on the perimeter of the inflated heart structure 11 and adjacent the mat 15 to provide an entrance (II) to the walk-through passageway 12. The entrance (II) (and thus, the representation of the superior vena cava (A)) is enlarged and disproportioned to accommodate most visitors. Referring to FIG. 3F, the representation of the superior vena cava (A) leads to a slit curtain or leaflet 19 representing the tricuspid valve (C). The curtain or leaflet 19c is preferably white to off-white in color to contrast the red color of the walls of the passageway 12. At the exhibit's position and orientation of the heart, the aorta (K) is placed generally next to the superior vena cava (A) on the perimeter of the heart structure and also adjacent the mat 15. One portion of the aorta (K) is also enlarged and opened to provide the exit (XX) of the heart structure 11. The rest of the aorta (K) appears as a nob on the top of the model 11 adjacent the exit (XX).

The all-around walls of the passageway 12 is primarily provided by inflated chambers of the heart structure, which also serve as safety padding. FIG. 3F depicts a portion of the left ventricle (G) in the passageway 12 and a portion of the mitral valve (H) represented by a curtain 19h. As mentioned above, the valves in the passageway 12 may be represented by an opaque plastic (or vinyl) sheet or curtain. In the case of the tricuspid valve (C) and the aortic valve (S), a slit is provided in the curtain (19c, 19s) to allow visitor access therethrough. Preferably, in the case of the mitral valve (H), the curtain or sheet 19h is secured to prevent passage. In the case of the pulmonary valve (E), an inflated protrusion or bulb 19e is provided on the top of the wall just past the tricuspid valve (C), as shown in FIG. 3C.

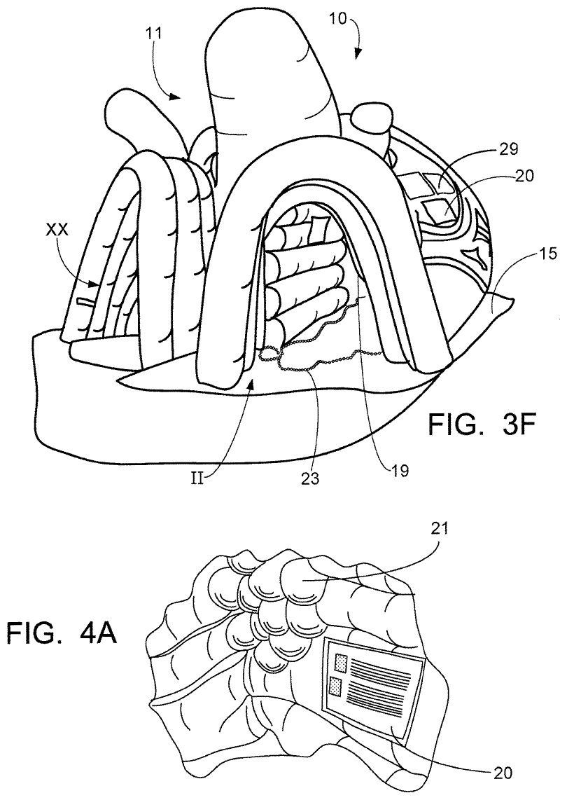

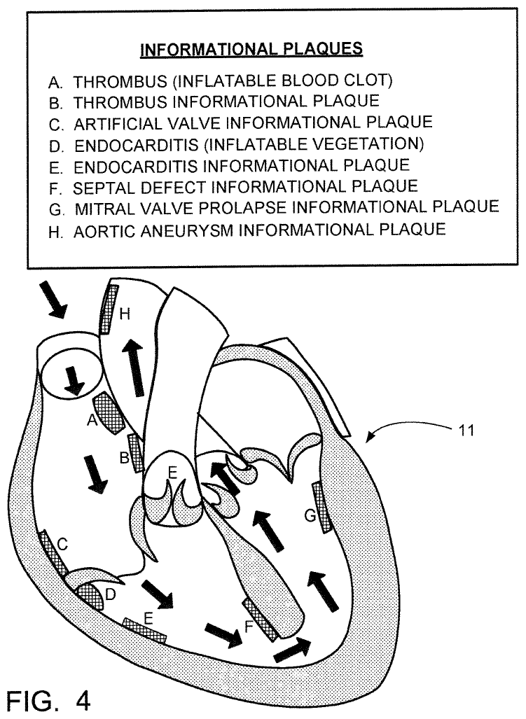

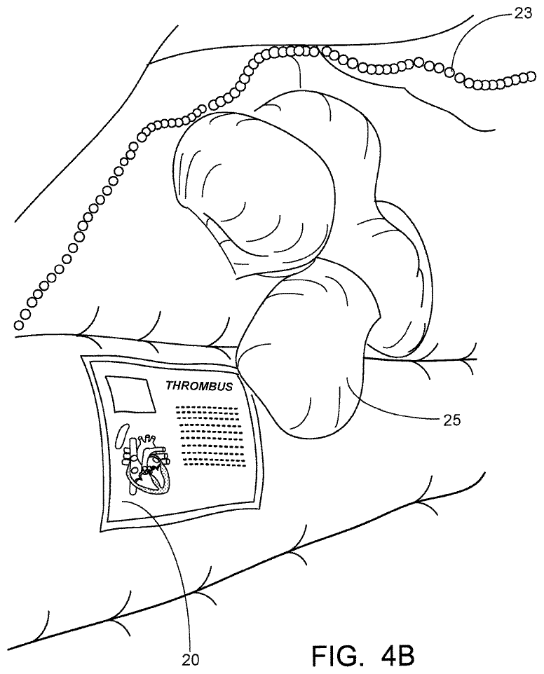

In yet another aspect, the three-dimensional walk-through passageway 12 provides another educational platform to present additional information regarding the heart (besides observation of the internal structure and components). The walls of the passageway 12, which correspond to internal portions of the heart (e.g., chamber walls), are used to display informational plaques 20 relevant to that portion of the heart. FIG. 4 provides a map of various locations along the passageway 12 at which a plaque 20 may be placed. For example, a plaque 20 relating to the septal defect condition is placed next to the opening in the septum (F) between the right and left ventricles (D, E). Also, a plaque 20 relating to the disease known as mitral valve prolapse is placed next to the mitral valve (G) (see also FIG. 3E). In some cases, the plaque 20 is accompanied by a three-dimensional physical representation 21 of the disease information (e.g., the result of the disease itself or its symptoms). For example, the plaque for septal defect is accompanied by an opening (O) illustrating the defect in the septum (F).

FIG. 4A depicts a plaque 20 provided on a wall of the right ventricle (D) next to the tricuspid valve (C) accompanied by a three-dimensional form or representation 21 of the condition known as endocarditis. Endocarditis is an inflammation of the inner layer of the heart and usually involves the heart valves. The disease is characterized by a lesion that appears as a mass(es) on the heart lining. As shown in FIG. 4A, the lesion or masses are represented as off-color protrusions or bulbs 21 adjacent the tricuspid valve (C). The plaque 20 describing the condition is placed next to the bulbs 21. The bulbs 21 may be constructed from a layer of fabric sewn to the wall of the passageway 12 and including an inlet in communication with the larger inflated chambers that make up the walls of the passageway.

FIG. 4B depicts a wall in the right atrium (B) on which another plaque 20 is placed. The plaque 20 describes a condition known as thrombus that affects the wall of the heart. Sometimes blood flows more slowly through the blood vessels and forms blood clots or thrombi. The blood clots are simulated as abnormal growths on the walls of the passageway 12. The abnormal growth may be provided by individually inflated bags 25 attached to the wall. The plaque 20 is placed is placed next to the three-dimensional representation 25 of the condition on the wall of the right atrium (B) and readily observable by a passing visitor.

In further embodiments, the chambers that make up the walls of the passageway 12 may be designed and operated (by the inflation system) to contract and expand. By coordinating the contraction and expansion of the various portions of the heart structure, the movement of the beating heart may be simulated and observed by a visitor traveling the passageway 12. The experience may be further enhanced by incorporating and synchronizing audio (e.g., of a normal/or and abnormal beating heart) with the movement of the walls. In further embodiments, the blood vessels on the walls of the passageway 12 (or outside surface 29) may be provided by transparent elongated tubes through which simulated blood travels. A simple low pressure pumping system may be connected with the tubes to drive synchronized blood flows. Color fluids may be used to simulate and distinguish oxygenated and de-oxygenated blood flow

Interior illumination of the movable, inflatable structure 11 can be particularly challenging. Much of the walk-through passageway 12 is a fairly narrow space that is bounded and substantially confined by the side walls, floor and ceiling. Yet, a primary purpose of the exhibit 10 and the walk-through passageway 12 is to visually present features of the heart attributed to the interior walls of the passageway 12. As shown herein, the various embodiments of the invention take advantage of visual representations and reading material to convey information. The passageway 12 itself is a platform for the presentation materials. In some embodiments, lighting strings 23 may be secured about the walls and flow of the passageway 12 as described. In a preferred embodiment, to enhance viewing within the walk-through passageway, strips of Velcro™-mounted micro light-emitting-diode (LED) lights are selectively placed throughout the passageway 12 and used to illuminate the passageway and the information presented therein.

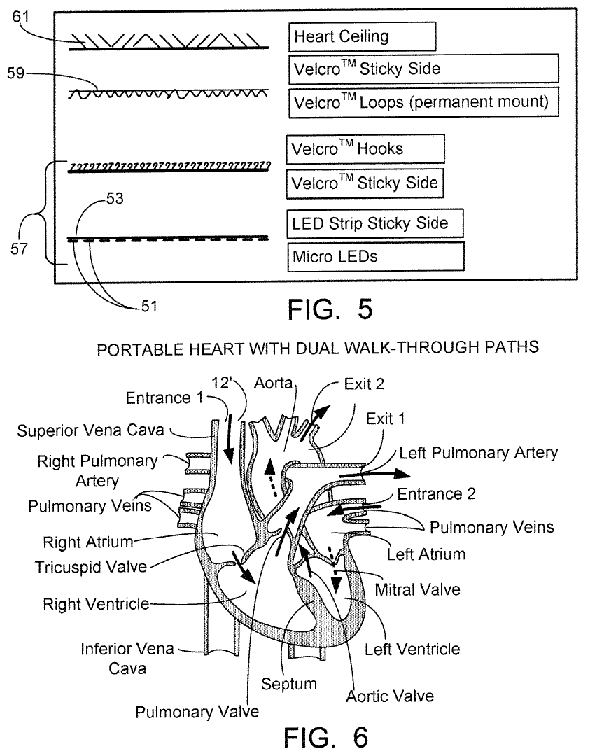

A preferred construction of these lighting devices is illustrated in the exploded schematic of FIG. 5. The LED lights are solid state devices that can illuminate effectively without requiring the heating of a filament. Thus, very little heat gain is generated inside the model 11. Referring to FIG. 5, the micro-LEDs 51 are mounted to the adhesive side of a flexible polymeric substrate 53. This substrate 53 is, in turn, attached with the “hook” side 55 of a Velcro™ hook and loop system, to make a flexible, attachable strip of LED lighting. The other part of this strip system is a base strip 59 of the Velcro™ loop layer, which is attached along the wall or ceiling 61 of the walk-through passageway. This strip lighting system, with its Velcro™ hook and loop attachment system, facilitates attachment and removal of the LED lights. The base strip 59 may be permanently located along or on the desired location in the walk-through passageway. During set up, and after inflation of the structure 11, the flexible LED strip 57 may be easily matched with the permanent locations of the base strip 59. Of a particularly low profile, the LED strip lighting system is unobtrusive and occupies minimal space in the walk-through passageway 12. The LED strip lighting system, therefore, enhances the viewing aspect of the model 11 and also facilitates the set-up and breakdown of the inflatable structure.

Other methods of illumination, such as the provision of transparent plastic windows along the walls of the passageway may also be employed.

The outside of the infrastructure 11 also serves as a presentation platform of the exhibit 10. As shown in FIG. 3 the outside surface 29 also displays features of the heart (and heart disease). These features include the shape and contour of portions of the heart, the veins on the outside of the heart, as well as both vena cava and pulmonary arteries. The outside surface may also accommodate informational plaques 20 and physical representations 21 of diseases or defects, as described previously. In further embodiments, the outside surface 29 may be equipped with transparent windows allowing views into the inside of the heart. The veins may also be provided by transparent or almost transparent tubes or sacs to simulate blood flow or blood conditions. In various embodiments, the veins are provided in bluish and reddish tones to represent transport of de-oxygenated and oxygenated blood, respectively. Thus, in one respect, the outside surface 29 of the model 11 is an extension of a continuous informative walk-through passageway 12 of the exhibit 10 that enters and exits the inside of the heart model 11 as well as traversing the perimeter of the heart model 11.

FIG. 6 illustrates an alternative embodiment of an exhibit according to the present disclosure and more particularly, an alternate walk-through passageway (represented by a sequence of directional arrows). The walk-through passageway may be incorporated with other elements of the exhibit as described previously in respect to FIGS. 2-4. The alternative passageway 12′ allows the visitor to take the pathway that blood takes in the heart. Deoxygenated blood enters the right side of the heart (Entrance 1) and is then pumped out of the heart via the pulmonary artery (Exit 1) to the lungs where it is oxygenated. The oxygenated blood then reenters the left side heart via the pulmonary veins (Entrance 2) and then pumped out to the body via the aorta (Exit 2). In further embodiments, a walk-through representation of the lungs is incorporated with the heart structure. In this way, the visitor's pathway corresponds with the actual path taken by blood circulating in the heart and lungs, and perhaps the rest of the human body. In these embodiments, inflatable representations of the pulmonary arteries would serve to direct the visitor from the right ventricle of the heart to the lung(s) and then back again into the left atrium via inflatable representations of the pulmonary veins.

### Augmented Reality and Virtual Reality

In some aspects, the exhibits disclosed herein include at least one virtual reality (VR) or augmented reality (AR) feature. The VR and/or AR feature may be viewable via a VR or AR headset, a smartphone, a tablet computer, a laptop computer, or another VR or AR enabled device or display screen. The VR or AR feature may represent any of the features disclosed herein, including organ function, organ tissue or section, organ disease, and organ treatment. For example, the heart exhibit described above with respect to FIGS. 1-6, or any portion, feature, activity, or ailment thereof, may be represented using the VR and/or AR features disclosed herein. Some VR and/or AR features may include moveable elements that may, for example, simulate organ function, such as a beating heart or an inhaling and exhaling lung. For example, VR and/or AR renditions may present renditions of the beating of the heart, including the opening and closing of valves and the movement of the walls of the heart; the flow of blood though the body, including through the heart; the movement of the lungs during inhalation and exhalation; the growth of tumors; the spread of cancer; the biomechanical movement of body parts, such as the bending of the arm at the elbow; and other movements of or within the organ being exhibited.

In some embodiments, the VR and/or AR technology disclosed herein is used in conjunction with a physical exhibit of an organ, such as the inflatable human heart exhibit described with reference to FIGS. 1-6 above, or the inflatable brain exhibit described in the '058 application, or inflatable exhibits of other organs, such as a liver or lungs. The VR and/or AR technology disclosed herein is not limited to use with inflatable exhibits, and may be used in conjunction with non-inflatable exhibits. Furthermore, in some embodiments, VR technology is used to generate a virtual walk-through exhibit of an organ, such that the need for a physical exhibit of an organ is eliminated and the VR technology is used to provide an entirety of the exhibit of the organ without a physical exhibit of the organ.

While physical exhibits of organs, such as those disclosed in the '058 application and the '786 patent, are useful alone, the ability to use such exhibits with AR technology and/or VR technology incorporated therein provides for the ability to enhance the explanation of key features of the organs. AR involves combining the physical world with the digital world, such as by allowing users to walk through a physical exhibit of an organ while also providing them with additional information about and/or views of the organ using AR renditions of the organ, portions of the organ, or information related to the organ. VR is a computer-generated recreation of an environment in which users can immerse themselves in the environment. The combination of viewing a larger-than-life organ and having AR and/or VR features incorporated into the exhibit provides a powerful, engaging learning experience.

In some embodiments, a portable, walk-through exhibit of an organ, such as the human heart, is provided. The portable, walk-through exhibit may be a physical exhibit, such as the exhibit described above with respect to FIGS. 1-6, that is augmented with AR and/or VR features. In some embodiments, the physical exhibit is inflatable. In one exemplary embodiment, portability of the exhibit is achieved, at least partially, by fabricating the physical exhibit from lightweight and/or low-permeability materials, such as polyvinyl chloride (PVC). For example, the physical exhibit may be fabricated from a low-permeability polymer PVC or other fabric or material. Low-permeability materials provide for the ability to inflate the physical exhibit (e.g., with air), with the exhibit being capable of retaining or substantially retaining the air to stay inflated.

As exemplified above with respect to the human heart, the physical exhibit (also referred to herein as a “model”) may be designed in such a manner that a visitor can walk through the organ. For example, in one embodiment of the heart exhibit, the visitor enters via the right atrium of the heart, passes through a simulated ventricular septal defect (hole) at the vertex end of the septum, and then passes out of the heart through the left atrium. The septum is the major wall of the heart that separates the right ventricle from the left ventricle. Other walk-through patterns through the human heart (and other organs) are also possible without departing from the scope of the present disclosure.

In some embodiments, AR and/or VR features are used to provide visitors (also referred to herein as “users”) with further explanations of, for example, the workings of the human body and the effects of various diseases. In one exemplary embodiment, visitors can place an AR and/or VR user interface, such as a smart phone or tablet, near a feature of an exhibit, such than an AR and/or VR rendition of the feature of the exhibit is initiated and is displayed on the AR and/or VR user interface, such as the display of a mobile phone. With the use of such an AR and/or VR user interface, the visitor is enabled to view, within the AR and/or VR rendition of the feature, and to move around within the AR and/or VR rendition of the feature (i.e., move the view).

In one embodiment, an organ exhibit includes VR renditions of features of the exhibit. For example, a VR user interface may be or include VR goggles or a VR headset that provides visitors with the ability to see virtual red blood cells within the organ as the visitors traverse through the organ. In some embodiments, the exhibit is entirely a virtual rendering that is presented to the visitors on a VR user interface, such as a VR headset, such that the visitors are provided with the ability to walk through the organ without requiring any physical model of the organ. The VR user interface could be programmed such that the visitors feel as if they are walking or floating through an anatomical model of a human body part.

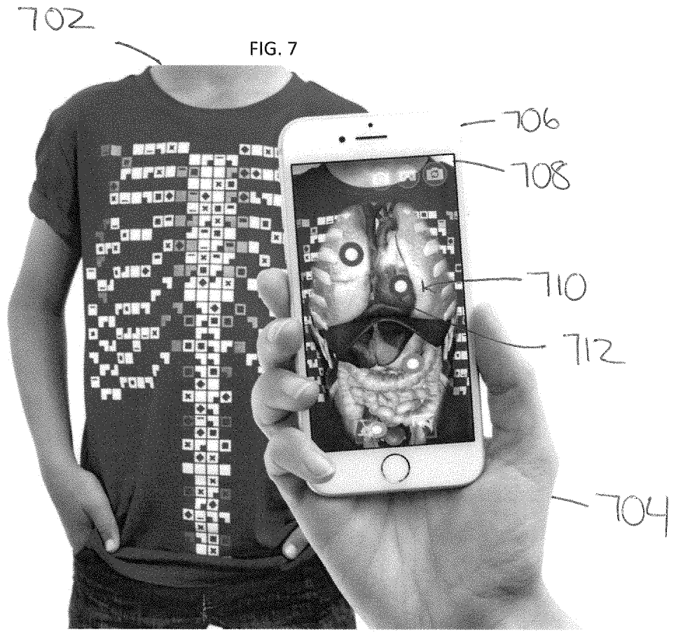

Having briefly described the AR and VR features of the present disclosure, reference is now made to FIGS. 7-17, which provide further details regarding the implementation of AR and VR technology to model human organs or augment an existing model of a human organ, including the generation of a graphical user interface (GUI) for presentation of the AR or VR renditions in a manner that allows the visitors to customize the AR or VR renditions by making selections within the GUI. Applicant notes that the hardware and software for generating and displaying virtual reality and augmented reality features to users is well known to those skilled in the art and, thus, does not require a detailed explication herein. For example, the Oculus Rift, Microsoft Hololens, and Sony Morpheus are just a few examples of VR user interfaces that may be used to generate and display VR renditions to users. Also, APPLE INC.'s ARKit 3 is just one example an AR software platform for use in the generation and display of AR renditions to users.

FIG. 7 depicts a subject person 702 and a user 704. User 704 is holding user interface 706 such that a camera (not shown) of user interface 706 captures an image of a portion of subject person 702. User interface 706 executes a software program that generates an AR rendition of organs of the subject person 702. As shown in in FIG. 7, the lungs 710 and heart 712, among other organs, are rendered on display 708 of user interface 706. As shown, user interface 706 is a smart phone. User interface 706 may include the software program that generates the AR rendition stored locally within a non-transitory data storage of user interface 706 (e.g., as an App). Alternatively, the software program may be stored in a remote administrative data storage of a host computer that is operated by another party, and the user interface 706 may be in communication with the host computer, such as through a cellular network or the internet. Alternatively, the software program that generates the AR rendition may be stored remotely within a cloud storage account that is linked to the user interface 706. Regardless of where the software is stored and hosted, the user 704 is capable of initiating the generation of the AR rendition using the user interface 706. In some embodiments, the AR or VR rendition is generated via an image captured by a camera of the user interface 706, such as the image of a QR code or a bar code that is associated with the AR or VR rendition. In other embodiments, the AR or VR rendition is generated via physical proximity to a device (proximity sensor) that initiates generation of the AR or VR rendition. For example, in some embodiments the location of the user interface 706 throughout an exhibit can be tracked via Bluetooth proximity sensors and/or Wi-Fi-based proximity sensors, and the software program can initiate the user interface 706 to generate an AR or VR rendition based upon the location of the user interface 706. For example, as the user enters the pulmonary artery, the user interface 706 may generate and display an AR or VR rendition of or related to the pulmonary artery. If the user then moves into the aorta, then the user interface 706 can generate and display an AR or VR rendition of or related to the aorta based upon the tracked location of the user interface 706 relative to the exhibit.

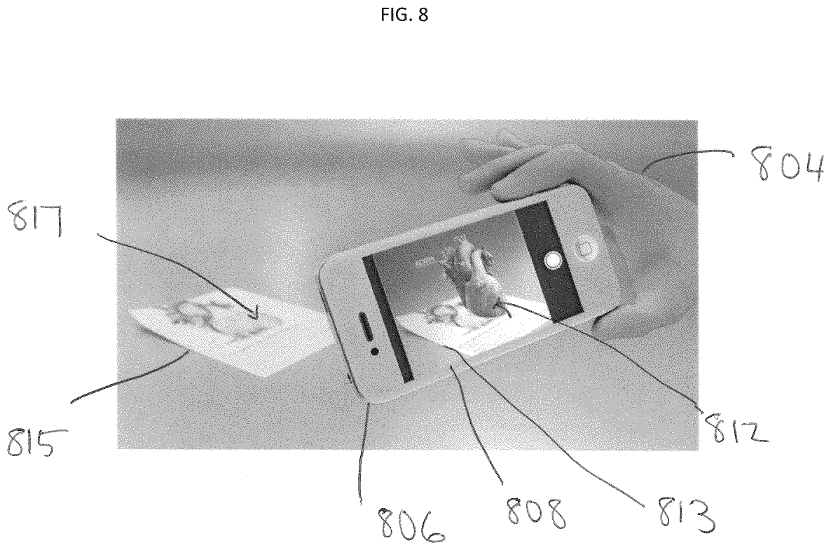

FIG. 8 depicts user 804 holding user interface 806. In some embodiments, the software program may include Artificial Intelligence (AI) programming enabling the user interface 806 to recognize objects within the view of the camera of the user interface, and such recognition can initiate the generation and display of the AR or VR rendition. For example, in FIG. 8 informational plaque 815, which is may be position on, in, or near an organ exhibit, is within the view field of the camera of user interface 806, such that an image of plaque 813 is presented in display 808 of the user interface 806. On the informational plaque 815 is a pictorial representation of a human heart, 817. The software program may include AI programming with the ability to recognize the picture as a representation of a human heart, such that the AR rendition of the human hear 812 is generated is displayed on display 808 of user interface 806. Of course, the information plaque 815 may have a QR code or bar code thereon that is scannable via the user interface 806 to initiate the generation and display of the AR rendition of the human hear 812, rather than relying on the above discussed AI. Also, the informational plaque may have a proximity sensor on or near it such that the generation and display of the AR rendition of the human hear 812 is initiated in response to physical proximity. Such informational plaques can be placed throughout the exhibit to provide visitors with various opportunities to supplement the exhibit with AR and/or VR features throughout their tour of the organ.

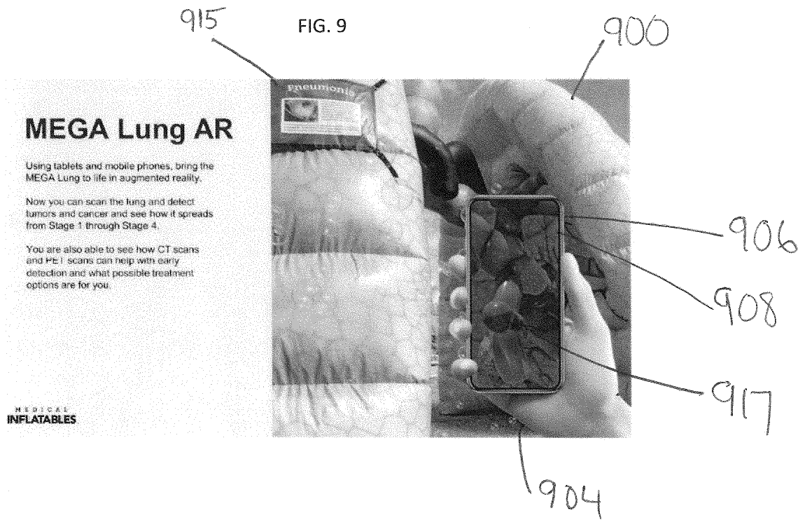

FIG. 9 depicts user 904 holding user interface 906 such that a camera of user interface 906 is capturing a view of a portion of exhibit 900. Exhibit 900 is an inflatable exhibit of the human lungs, and includes informational plaque 915 thereon. In this particular example, informational plaque 915 provides information regarding pneumonia, a common ailment that affect the lungs. Informational plaque 915 may include a QR code, bar code, proximity sensor, or some other mechanism such that the AR/VR software program of user interface 906 initiates the AR/VR rendition 917 of the lungs and/or a feature associated therewith. In the example of FIG. 9, the AR/VR rendition 917 depicts a graphical display of the effects that pneumonia has on the lungs. Using such AR/VR technology, visitors are capable of bringing the lung exhibit “to life” in the AR/VR rendition. For example, users can use an AR/VR user interface to scan the lung exhibit to detect tumors, cancer, or other ailments, and to see how such ailments spread within the organ, such as how cancer spreads from Stage 1 to Stage 4. For example, the software program may be programmed such that a location in the exhibit is indicated as displaying signs of disease, such that when the user interface is in physical proximity to such a location (or scans a bar code or QR code at the location), the AR/VR user interface indicates the presence of the disease. Furthermore, the AR/VR user interface may also allow visitors to view how CT scans and PET scans, which can be used to facilitate early detection of ailments such as cancer, and the AR/VR user interface can display possible treatment options that are available for the detected disease.

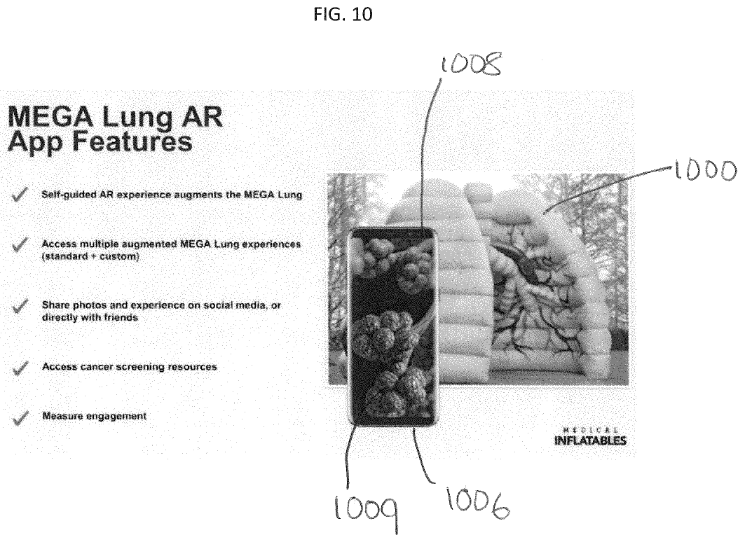

FIG. 10 is another view of an inflatable lung exhibit, exhibit 1000. User interface 1006 includes display 1008, which is displaying lung feature 1009. Lung feature 1009 may be representative of, for example, a portion of the lung, an ailment of the lung, or a treatment option for an ailment of the lung. With user interface 1006, visitors are provided with a self-guided tour of the lung exhibit 1000 with various AR and/or VR renditions. The AR and/or VR renditions available to visitors may be standardized, such that all users view the same AR and/or VR renditions, or may be customized, such that each user can choose at least certain aspects of interest. For example, one visitor may be interested in cancer within the lungs, and may choose to generate AR and/or VR renditions that provide information on cancer throughout the lung exhibit, while another visitor is interested in pneumonia and its effects on the lungs and may choose to generate AR and/or VR renditions that provide information on pneumonia throughout the lung exhibit. These user customizations may be made prior to entering the exhibit, and/or throughout the exhibit. For example, exhibit 1000 may include multiple informational plaques around and throughout exhibit 1000. At each informational plaque, the visitor may have multiple options of which AR and/or VR rendition to view, such as a cancer-related rendition and a pneumonia-related rendition. Of course, in such embodiments, the user may choose to view both renditions, sequentially.

In some embodiments, the user interface 1006 is configured such that the visitors of the exhibit can take photographs and/or videos and can share or post such photographs or videos on social media (e.g., Twitter) or directly with friends or family (e.g., via text). Such capabilities may be directly integrated into the App that generates the AR or VR rendition. For example, the App may include a “share” button that allows particular screenshot or other aspect of an AR or VR rendition to be posted onto a social media web site or shared via text.

The App may also provide visitors with access to medical resources, such as cancer screening resources, such as via a link to such websites associated with such resources.

The App may also be used by a host, such as the entity that is providing the organ exhibit, to measure engagement with the exhibit. For example, the App may collect data regarding the use of the AR or VR renditions, and regarding the use of the sharing features of the App.

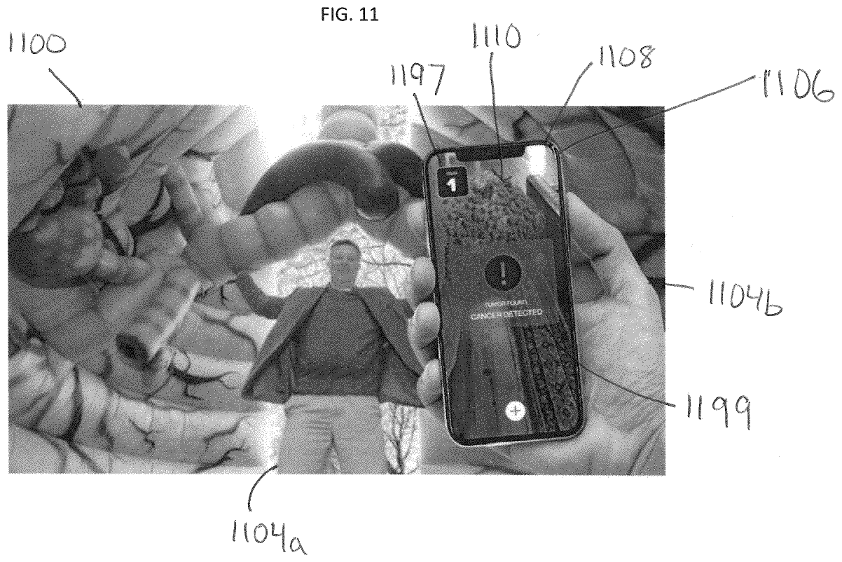

FIG. 11 depicts a portion of lung exhibit 1100, with visitors 1104a and 1104b. Visitor 1104b is holding user interface 1106. Display 1108 of user interface 1106 is displaying a three-dimensional AR rendition 1110 of the lungs. The AR rendition 1110 is also displaying message 1199 indicating that a tumor has been found in the lungs and that cancer has been detected. Such messages can be programmed as part of the AR rendition 1110, and can provide the visitors with the opportunity to learn about the detection, status, and treatment of such ailments. In addition, AR rendition 1110 is also displaying message 1197 indicating the current stage of the AR rendition 1110 that the user is immersed within. The stage of the AR rendition may correspond with a stage of a disease. For example, stage 1 of the AR rendition may display information and images related to stage 1 cancer.

FIGS. 12A-12C depict an AR rendition of the lungs used in association with a physical exhibit of the lungs. In FIG. 12A, user interface 1206 (here a tablet computer) is presenting an exemplary welcome screen 1289 of a graphical user interface (GUI) of the App disclosed herein on display 1208. Welcome screen 1289 includes a “continue” touchscreen button 1287, allowing a visitor to select to initiate the AR and/or VR features while the visitor walks through the physical exhibit of the lungs. With the App installed on a user interface, the visitor is capable of walking around and/or through the lung exhibit and scanning the exhibit with the camera of the user interface. As shown in FIG. 12B, after initiating the AR and/or VR features of the App, the GUI includes a “scan” touchscreen button 1285. A visitor can touch button 1285 to initiate the App to scan the physical exhibit through the frame of the camera of user interface 1206 as the visitor walks around the exhibit. This allows the visitor to “scan” the exhibit for tumors. The GUI presents a digital, AR rendition of the lungs 1210 within display 1208 while the visitor walks around the exhibit. The GUI also presents a stage 1297, and informational plaque 1215.

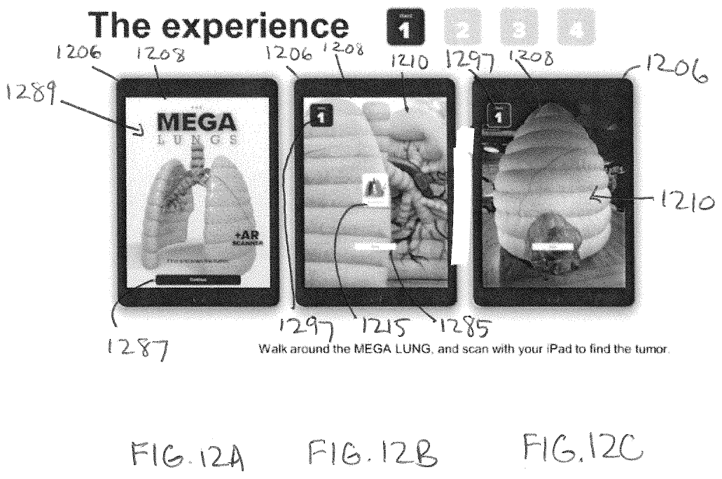

FIGS. 13A-13C depict a user interface with a GUI that is presenting an AR rendition of the same lung exhibit as FIGS. 12A-12C, but at stage 2. In stage 2, the GUI presents, in display 1308 of user interface 1306, a touchscreen button 1379 that allows the visitor to view CT scans associated with the lungs and lung ailment diagnosis, as well as a touchscreen button 1377 that allows the visitor to view treatment options for the subject ailment of the AR rendition. The GUI also displays an AR rendition 1310 of the lungs, a stage indicator 1397, and a “scan” touchscreen button 1385.

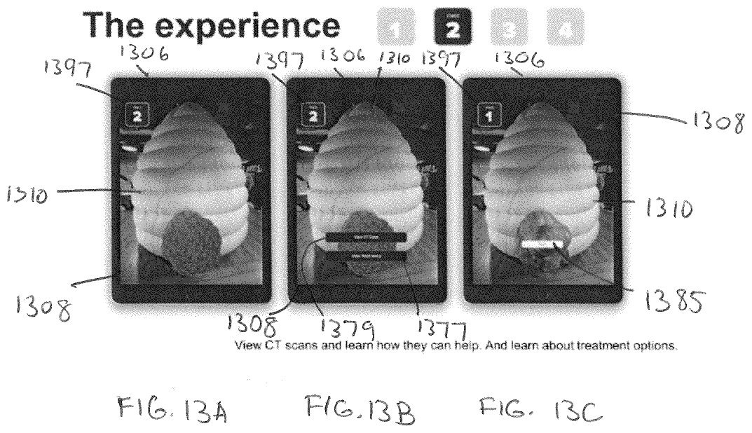

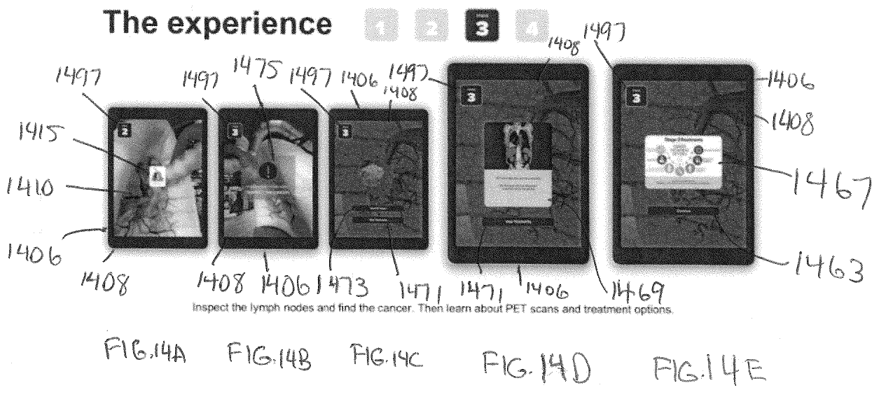

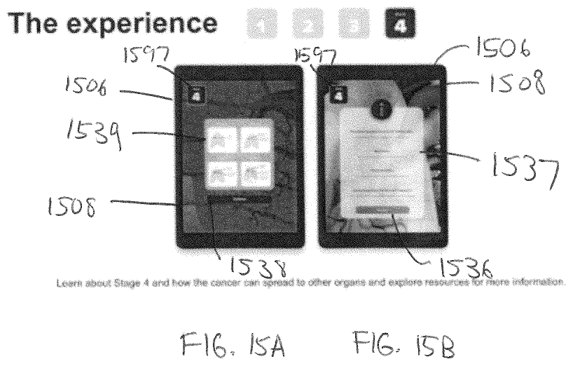

FIGS. 14A-14E depict a user interface with a GUI that is presenting an AR rendition of the same lung exhibit as FIGS. 12A-13C, but at stage 3. The lung exhibit is scanned using user interface 1406. During the scan, the GUI presents a message 1475 in display 1408 indicating that cancer has been found in the lymph nodes, and suggesting that the visitor inspect the lymph nodes. For example, a bar code or QR code on informational plaque 1415 may initiate message 1475. The visitor has the options of viewing PET scans by touching button 1473 and/or viewing treatment options by touching button 1471 within the GUI. When button 1473 is selected, the GUI will present PET scan 1469 in display 1408. When button 1471 is selected, the GUI will present treatment options 1467 in display 1408. At the end of stage 3, the GUI can present a “continue” button 1463 allowing the visitor to continuous the tour using the AR rendition features of the App. Also shown is stage indicator 1497.

FIGS. 15A and 15B depict a user interface with a GUI that is presenting an AR rendition of the same lung exhibit as FIGS. 12A-14E, but at stage 4. The GUI presents information 1539 in display 1508 of user interface 1506 regarding stages 1-4 of cancer, as well as a “continue” button 1538 allowing the visitor to move on to the next screen of the GUI, presenting information 1537 about other medical resources. For example, information 1537 may be or include links to websites that provide information about cancer and the treatment thereof, such as information regarding cancer risk factors, cancer screening, CT scanning, and treatment options. The GUI also presents a “restart” button 1536 allowing the visitor (or another visitor) to restart the tour of the exhibit using the App. Also shown is stage indicator 1597.

Without being bound by theory, it is believed that the use of the App disclosed herein to present AR and/or VR features will: enhance the ability to demonstrate body and disease processes to visitors; enhance the ability to demonstrate medical interventions to visitors; create more memorable and shareable visitor experiences; increase visitor engagement with exhibits; provide for stronger patient follow-up calls to action; collect visitor data; provide for customized visitor experiences; or combinations thereof.

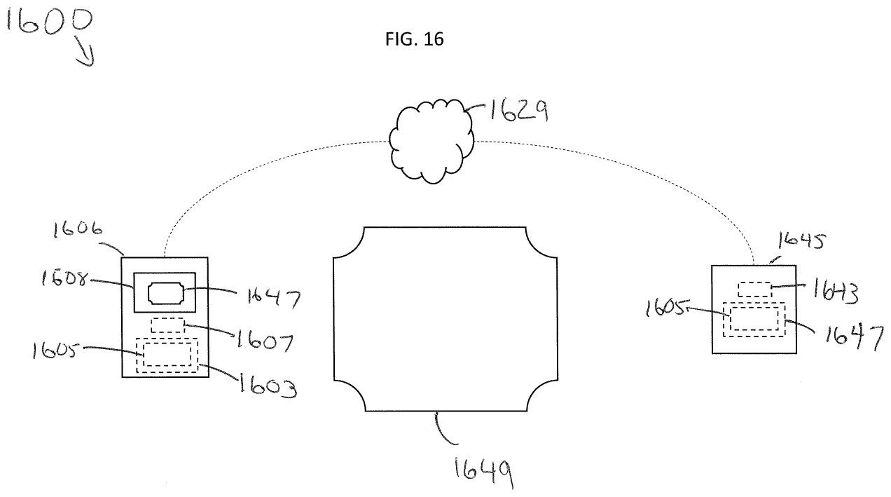

With reference to FIG. 16, one exemplary embodiment of a system 1600 for generating AR and/or VR features associated with a physical exhibit is depicted. System 1600 includes physical exhibit 1649, which may be an inflatable model of a human organ. System 1600 includes user interface 1606. User interface 1606 may be a smart phone, tablet computer, laptop computer, VR or AR enabled goggles, or a VR or AR enabled headset, for example. User interface 1606 may be a device brought to the exhibit by the visitor and having an App 1605 stored on a local data storage 1603 thereof, and a processor 1607 for executing the software of App 1605, such as for generation of a GUI that presents an AR rendition 1647 of the exhibit 1649 on display 1608. User interface 1606 may also be a device that is temporarily given to the visitor for use during the tour of the exhibit 1649.

Alternatively, or in addition to having App 1605 stored on user interface 1606, App 1605 may be stored in the data storage 1647 of a remote computer 1645 having a processor 1643. The remote computer 1645 may be a cloud storage associated with or linked with the user interface 1606 or may be a host computer that hosts the App 1605. The remote computer 1645 may be in communication with the user interface 1606 via network 1629, which may be a wireless or wired communication network. As such, the remote computer 1645 can execute at least some of the computer instructions of the App 1605, and can send instructions to the user interface to display the GUI on the display 1608.

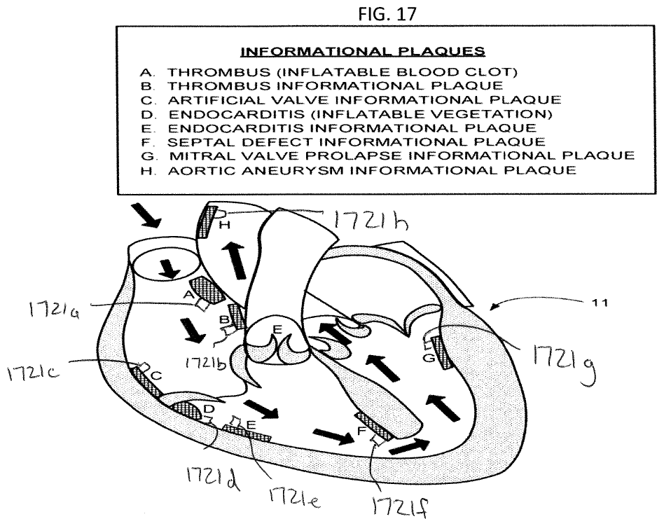

With reference to FIG. 17, a modified reproduction of FIG. 4 above, locations where bar codes, QR codes, Bluetooth signals, or other mechanisms for initiating various AR or VR features throughout the model 11 can be positioned are indicated. For example, as a visitor enters the visitor may first encounter an exhibit of thrombus. The user interface used by the visitor may initiate the presentation of an AR or VR feature on the display thereof when the visitor is at location A. The initiation of the presentation of an AR or VR feature on the user interface as the user view location A in model 11 may occur as a result of the user scanning a bar code or QR code at location A, such as on an informational plaque located at location A, or by physical proximity of the user interface to the location A, such as via Bluetooth signals received and/or emitted by the user interface and emitted and/or received from a Bluetooth transmitter/receiver 1721a that is positioned at location A. As the visitor continues through the model 11, the visitor can repeat these steps at each of locations B-H to initiate AR or VR features associated with other aspects of the heart. Thus, the initiation of each of the AR or VR features described with reference to FIG. 17 may occur as a result of the user scanning a bar code or QR code at an informational plaque located at the particular location A-H, or by physical proximity of the user interface to the particular location A-H such as via Bluetooth signals received and/or emitted by the user interface and emitted and/or received from a Bluetooth transmitter/receiver 1721a-1721h positioned at the particular location A-H, respectively. The QR codes, bar codes, Bluetooth transmitters/receivers or other AR/VR initiators may be positioned at any of various locations throughout the model exhibits disclosed herein. For example, such AR/VR initiators may be positioned at the entrance and exit of the model exhibits, at one or more of the informational plaques of the model exhibits, and at other locations in, on, or throughout the model exhibits.

Thus, in some embodiments the present disclosure includes a method for providing educational information about a human organ that uses a portable, walk-through, model of the human organ. The model incorporates augmented reality, virtual reality, or combinations thereof to facilitate the illustration and explanation of features of the organ. The model can incorporate bar codes or QR codes at various points throughout the model, allowing visitors to quickly obtain additional information about a feature of the organ using the AR and/or VR features of the App. In some embodiments, the App that generates the AR features is stored in the cloud and is accessible on a smart phone, tablet, or laptop computer. In some embodiments, the augmented reality or virtual reality features of the exhibit are automatically triggered by physical proximity of the visitor to a feature of the model. In certain embodiments, the augmented reality or virtual reality features use haptic feedback. The augmented reality or virtual reality features disclosed herein provide a progressive experience to identify diseases (e.g., cancer), learn about the diseases, and explore treatment options.

The foregoing description of the present invention has been presented for purposes of illustration and description. It is to be noted that the description is not intended to limit the invention to the various systems, apparatus, and processes disclosed herein.

1. A system for exhibiting a human organ, the system comprising:
a physical model of the human organ, the physical model comprising an infrastructure presenting a three-dimensional representation of at least a portion of the human organ, at a scale of at least 10:1;
a walk-through passageway defined, at least in part, by the infrastructure, wherein the walk-through passageway is directed by or through representations of portions of the human organ;
an augmented or virtual reality initiator positioned relative to the physical model; and a software application stored in a non-transitory storage medium, wherein the augmented or virtual reality initiator is configured to initiate the display of an augmented or virtual rendition of at least a portion of the human organ, a feature of the human organ, or combinations thereof.

2. The system of claim 1, further comprising a user interface comprising a display, wherein the augmented or virtual rendition is displayed on the display.

3. The system of claim 2, wherein the user interface comprises a smart phone, a tablet computer, a laptop computer, a headset, or googles.

4. The system of claim 2, wherein the augmented or virtual rendition comprises haptic feedback on the user interface.

5. The system of claim 1, wherein the augmented or virtual reality initiator comprises a bar code that is readable by a user interface, a QR code that is readable by a user interface, or a proximity sensor that is configured to sense proximity of a user interface.

6. The system of claim 5, wherein the proximity sensor comprises a Bluetooth transmitter/receiver.

7. The system of claim 5, wherein the augmented or virtual rendition is automatically triggered in response to physical proximity of the user interface to a feature of the physical model.

8. The system of claim 2, wherein the software application is stored in the user interface.

9. The system of claim 1, wherein the software application is stored on a host computer, and wherein the host computer comprises cloud data storage that is in communication with a user interface via a communications network.

10. The system of claim 1, wherein the augmented or virtual rendition comprises a progressive display of identification of a disease, information about the disease, and treatment options for the disease.

11. The system of claim 10, wherein the disease is cancer.

12. The system of claim 1, wherein the feature of the human organ comprises an organ function, organ tissue, an organ section, an organ disease, an organ treatment, or combinations thereof.

13. The system of claim 1, wherein the augmented or virtual rendition includes a simulation of an organ function.

14. The system of claim 1, wherein the physical model is an inflatable model.

15. (canceled)

16. (canceled)

17. (canceled)

18. (canceled)

19. The system of claim 2, wherein the software application generates and presents a graphical user interface on the display of the user interface.

20. (canceled)

21. (canceled)

22. (canceled)

23. A method of providing information about a human organ, the method comprising:
displaying a physical model of the human organ, the physical model comprising an infrastructure presenting a three-dimensional representation of at least a portion of the human organ, at a scale of at least 10:1, wherein a walk-through passageway is defined, at least in part, by the infrastructure, wherein the walk-through passageway is directed by or through representations of portions of the human organ;
directing a visitor through the walk-through passageway; and
presenting an augmented or virtual reality rendition of at least a portion of the human organ, a feature of the human organ, or combinations thereof to the visitor, wherein the augmented or virtual reality rendition is presented on a display of a user interface.

24. The method of claim 23, wherein presenting the augmented or virtual reality rendition includes directing the visitor to scan a bar code or QR code to imitate the presentation of the augmented or virtual reality rendition.

25. The method of claim 23, comprising detecting physical proximity of the user interface to a feature of the physical model, wherein the presentation of the augmented or virtual reality rendition in the display is initiated by the detected physical proximity.

26. The method of claim 25, wherein the physical proximity is detected by a proximity sensor.

27. (canceled)

28. (canceled)

29. (canceled)

30. (canceled)

31. (canceled)

32. (canceled)

33. (canceled)

34. (canceled)

35. (canceled)

36. (canceled)

37. A virtual exhibit of a human organ, the virtual exhibit comprising:
a virtual rendition of a model of at least a portion of the human organ, the virtual rendition presenting a three-dimensional, virtual representation of at least a portion of the human organ, at a scale of at least 10:1;
the virtual rendition defining a virtual walk-through passageway that is directed by or through the virtual representation of the human organ;
wherein the virtual rendition is presented on a display of a user interface.

38. The virtual exhibit of claim 37, wherein the user interface comprises a virtual reality headset or virtual reality goggles.

39. (canceled)

40. (canceled)
